(19) United States
(12) Patent Application Publication
(10) Pub. No.: US 2020/0142176 A1
(43) Pub. Date: May 7, 2020

(54) ALIGNED TUBE RETAINERS

(71) Applicant: N2 Imaging Systems, LLC, Irvine, CA (US)

(72) Inventors: Darren M. Zack, Yorba Linda, CA (US); Jay Meyer, Snohomish, WA (US); Scott Richman, Princeton, NJ (US)

(21) Appl. No.: 16/182,441

(22) Filed: Nov. 6, 2018

(51) Int. Cl. G02B 23/12

(52) U.S. Cl. CPC G02B 23/125

(57) ABSTRACT

A tube retainer can include a body configured to abut a face of a tube, a plurality of flexure flanges extending radially outwardly from the body and configured to flex relative to the body to provide a retaining force to the body when installed in a housing assembly around the tube, and a plurality of flexure legs axially extending from the body from a tube contact side of the body. At least a portion of the plurality of legs can include an inner diameter that is less than an outer diameter of the tube to provide a centering force to the tube.

### BACKGROUND

### 1. Field

The present disclosure relates to tube retainers, e.g., for optical components such as image intensifier tubes.

### 2. Description of Related Art

Certain optical systems include an optical component (e.g., an image intensifier tube) that is installed therein to be aligned. In current structures, shift (e.g., manifested as decenter and tilt) caused by vibration and/or thermal cycling causes the optical component to fall out of alignment. Such conventional methods and systems have generally been considered satisfactory for their intended purpose. However, there is still a need in the art for improved aligned tube retainers. The present disclosure provides a solution for this need.

### SUMMARY

In accordance with at least one aspect of this disclosure, a tube retainer can include a body configured to abut a face of a tube, a plurality of flexure flanges extending radially outwardly from the body and configured to flex relative to the body to provide a retaining force to the body when installed in a housing assembly around the tube, and a plurality of flexure legs axially extending from the body from a tube contact side of the body. At least a portion of the plurality of legs can include an inner diameter that is less than an outer diameter of the tube to provide a centering force to the tube.

The body can include a flat disk shape. The body can define a center optical hole to allow light to pass to or from the tube. The body can include a plurality of circumferentially spaced holes through the disk shape.

The plurality of flexure legs can include an L shape. The plurality of flexure flanges can be asymmetrically positioned on the body.

The plurality of flexure flanges can be less thick than the body. The plurality of flexure flanges and flexure legs can include at least three of each, for example.

The tube retainer can be made of plastic (e.g., injection molded) or metal (e.g., additively manufactured). Any other suitable material is contemplated herein.

In accordance with at least one aspect of this disclosure, an optical assembly can include an optical tube and a housing assembly surrounding the optical tube, the housing assembly comprising a plurality of mounts. The optical tube can axially extend past the plurality of mounts. The optical assembly can include a tube retainer, e.g., as described above. The body of the tube retainer can be abutting a face of the optical tube. The plurality of flexure flanges can each be attached to a respective mount of the plurality of mounts such that each flexure flange is flexed relative to the body to provide a retaining force to the body to bias the tube axially into the housing assembly. The plurality of flexure legs can at least partially surround the optical tube, contact an outer diameter of the optical tube, and can be flexed outwardly by the outer diameter of the optical tube to provide a centering force to the tube.

In certain embodiments, the tube retainer can be sandwiched between the housing assembly and an optical component mount. The tube retainer can be screwed down to the mounts of the housing assembly to flex the flexure flanges, for example, or fastened in any other suitable manner.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1A is a perspective view of an embodiment of a tube retainer in accordance with this disclosure;

FIG. 1B is a perspective view of the embodiment of FIG. 1A, viewed from a tube retaining side;

FIG. 1C is a plan view of the embodiment of FIG. 1A;

FIG. 1D is a reverse plan view of the embodiment as shown in FIG. 1C, showing a tube retaining side;

FIG. 1E is a side view of the embodiment of FIG. 1A;

FIG. 1F is a cross-sectional side view of the embodiment of FIG. 1A;

FIG. 2A is a perspective view of the embodiment of a tube retainer of FIG. 1A shown disposed on an embodiment of an optical tube;

FIG. 2B is a perspective view of the embodiment of FIG. 2A, showing a portion of the tube retainer disposed on the optical tube;

FIG. 3A is a perspective view of the tube retainer attached to an embodiment of a tube housing;

FIG. 3B shows an exploded view of the embodiment of FIG. 3A;

FIG. 3C is a side perspective view of the embodiment of FIG. 3A; and

FIG. 3D is a partial perspective view of a flexure flange attached to the tube housing before being tightened down to flex.

### DETAILED DESCRIPTION

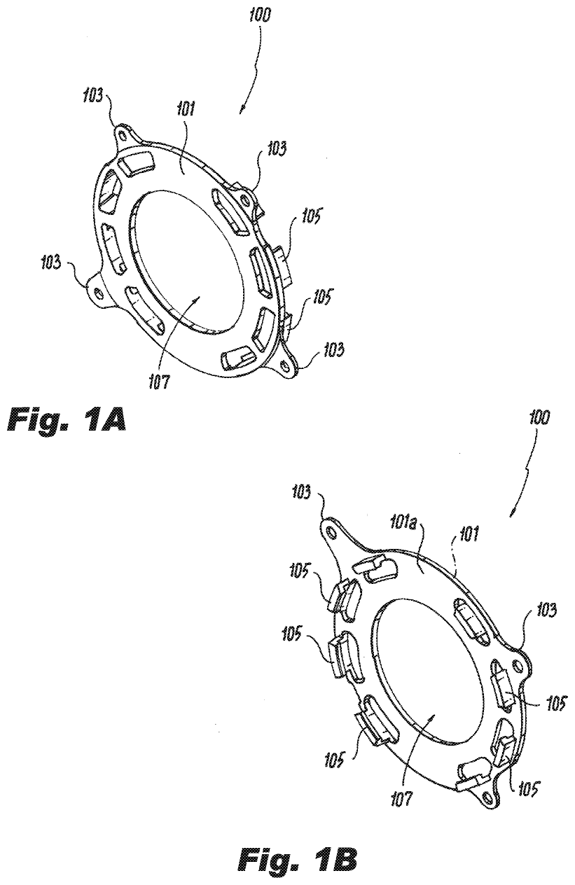

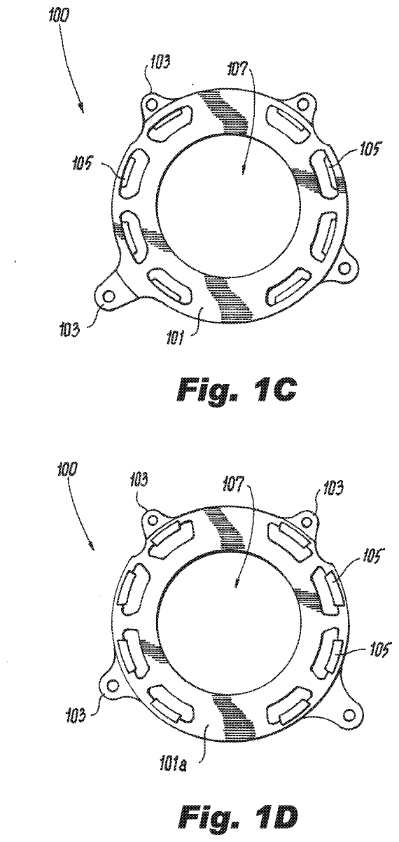

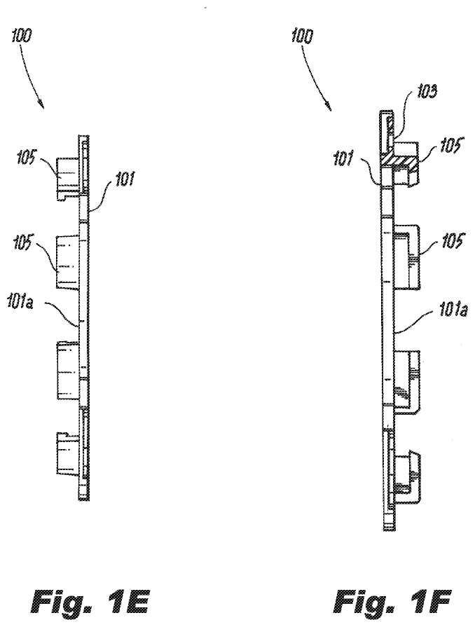

Reference will now be made to the drawings wherein like reference numerals identify similar structural features or aspects of the subject disclosure. For purposes of explanation and illustration, and not limitation, an illustrative view of an embodiment of a tube retainer in accordance with the disclosure is shown in FIGS. 1A and 1s designated generally by reference character 100. Other embodiments and/or aspects of this disclosure are shown in FIGS. 1B-3D.

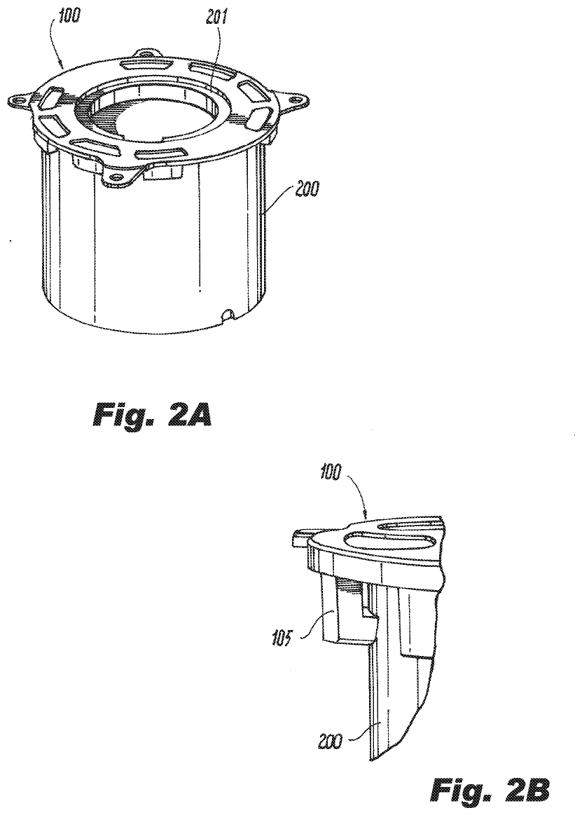

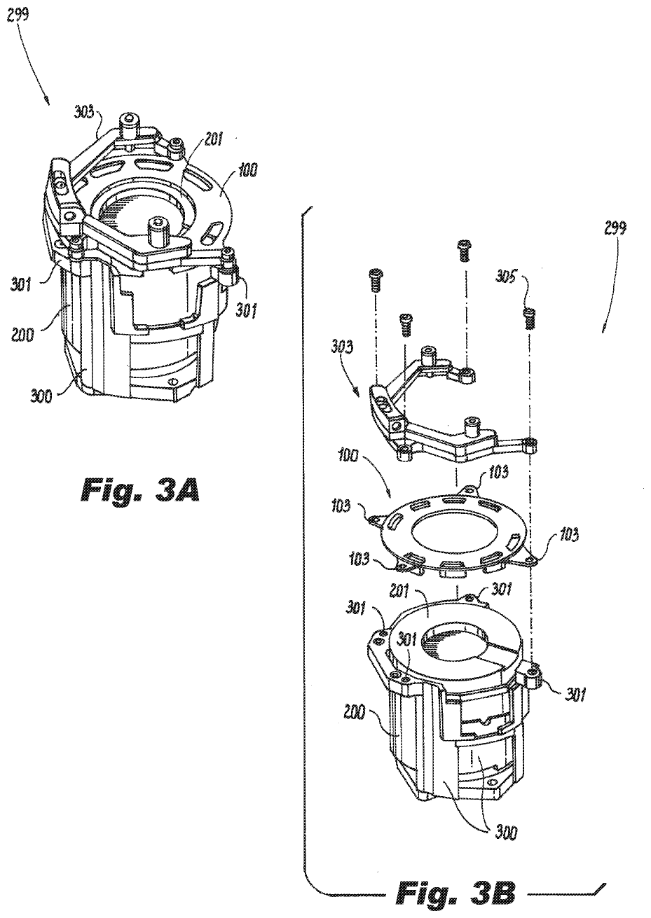

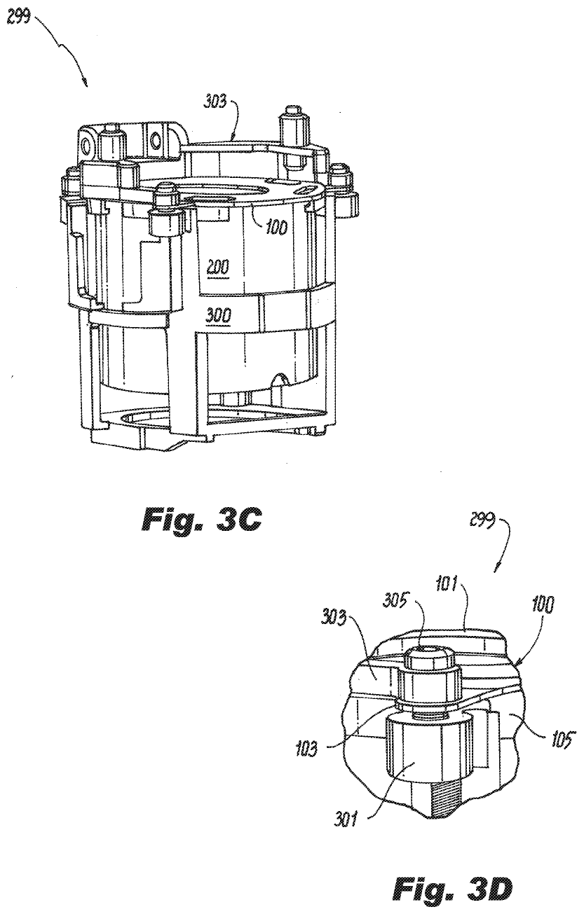

In accordance with at least one aspect of this disclosure, referring to FIGS. 1A-1F, a tube retainer 100 can include a body 101 configured to abut a face of a tube, e.g., as shown in FIGS. 2A-3D. The tube retainer 100 can include a plurality of flexure flanges 103 extending radially outwardly from the body 101 and configured to flex relative to the body 101 (e.g., in the axial direction) to provide a retaining force to the body 101 when installed in a housing assembly around the tube.

The tube retainer 100 can include a plurality of flexure legs 105 axially extending from the body 101 from a tube contact side 101a of the body 101. At least a portion of the plurality of legs 105 can include an inner diameter that is less than an outer diameter of the tube to provide a centering force to the tube (e.g., due to interference of with legs 105 such that the legs are flexed radially outwardly and provide a restoring force to the outer diameter of the tube).

In certain embodiments, the body 101 can include a flat disk shape. Any other suitable shape is contemplated herein (e.g., a shape that compliments a shape of the abutted face of the tube).

The body 101 can define a center optical hole 107 to allow light to pass to or from the tube. The body 101 can include a plurality of circumferentially spaced holes 109 through the disk shape (e.g., which can be required for injection molding). For example, each hole can correspond to a leg 105 such that each leg 105 can be injection molded.

As shown, the plurality of flexure legs 105 can include an L shape. Any other suitable shape is contemplated herein (e.g., angled inward from body 101). Any suitable number of legs 105 is contemplated herein.

The plurality of flexure flanges 103 can be asymmetrically positioned on the body 101 (e.g., to match with certain existing optical housings). Any other suitable positioning is contemplated herein. One or more flexure flange 103 can have the same dimensions, or can include different dimensions than one or more other flexure flanges 103. Any suitable number of flanges 103 is contemplated herein.

As shown, the plurality of flexure flanges 103 can be less thick than the body 101. The plurality of flexure flanges 103 and flexure legs 105 can include at least three of each (e.g., to at least provide at least three point stability), for example. As shown, certain embodiments can include four flexure flanges 103 and eight flexure legs 105.

The tube retainer 100 can be made of plastic (e.g., injection molded) or metal (e.g., additively manufactured). Any other suitable material and/or manufacturing method is contemplated herein.

Referring to FIGS. 2A and 2B, the tube retainer 100 is shown disposed on an embodiment of an optical tube 200 abutting a face 201 of the optical tube 200. FIG. 2B shows the legs 105 interfering with an outer diameter of the tube 200.

Referring additionally to FIGS. 2A-3D, in accordance with at least one aspect of this disclosure, an optical assembly 299 can include an optical tube 200 and a housing assembly 300 surrounding the optical tube 200. The housing assembly 200 can include a plurality of mounts 301. The housing assembly 200 can include one or more pieces configured to at least partially retain the optical tube 200.

As shown, the optical tube 200 can axially extend past the plurality of mounts 301 (e.g., which allows bending of the flexure flanges 103 when attached to the mounts 301 and when the body 101 abuts the face 201). The optical assembly 299 can include a tube retainer, e.g., retainer 100 as described above. The body 101 of the tube retainer 100 can abut a face 201 of the optical tube 200, as shown.

The plurality of flexure flanges 103 can each be attached to a respective mount 301 of the plurality of mounts 301 such that each flexure flange 103 is flexed relative to the body 101 to provide a retaining force to the body 101 to bias the tube 200 axially into the housing assembly 300. The plurality of flexure legs 105 can at least partially surround the optical tube 200, contact an outer diameter of the optical tube 200, and can be flexed outwardly by the outer diameter of the optical tube 200 to provide a centering force to the tube 200.

In certain embodiments, the tube retainer 100 can be sandwiched between the housing assembly 300 and an optical component mount 303. The tube retainer 100 can be screwed down to the mounts 301 of the housing assembly 300 to flex the flexure flanges 103, for example. A plurality of screws 305 can be used to attach the tube retainer 100 and/or the optical component mount 303. Any other suitable fastener is contemplated herein. When installed fully (not shown) the flanges 103 of retainer 100 can be compressed by a fastener (e.g., a screw 305), and bent down to contact the housing mount 301 which creates spring force pressing against tube 200.

Embodiments can be used for a two channel camera/imaging device (IR and near IR) to mount to helmet. Embodiments can include spring plungers (two posts extending from component mount 303) that hold weight of a dewar cooler assembly (not shown). These plungers were previously used to retain the tube exclusively, but this retention caused motion due to force application at only two points. Embodiments can still be additionally retained using the spring plungers.

Embodiments can retain the tube and prevent from decentering. Embodiments, reduce and/or eliminates decenter and tilt of the tube by grabbing the tube about the outer diameter with flexures. In addition, embodiments also apply an axial force against the tube, keeping the tube pressed in place.

While certain embodiments are shown having a tube of cylindrical shape, any suitable tube shape is contemplated herein (e.g., rectangular cross-sectional shape). While certain embodiments apply to optical applications, any other suitable application, e.g., those requiring alignment, is contemplated herein as well.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

Any suitable combination(s) of any disclosed embodiments and/or any suitable portion(s) thereof are contemplated herein as appreciated by those having ordinary skill in the art.

The embodiments of the present disclosure, as described above and shown in the drawings, provide for improvement in the art to which they pertain. While the subject disclosure includes reference to certain embodiments, those skilled in the art will readily appreciate that changes and/or modifications may be made thereto without departing from the spirit and scope of the subject disclosure.

What is claimed is:

1. A tube retainer, comprising;
a body configured to abut a face of a tube;
a plurality of flexure flanges extending radially outwardly from the body and configured to flex relative to the body to provide a retaining force to the body when installed in a housing assembly around the tube; and
a plurality of flexure legs axially extending from the body from a tube contact side of the body, wherein at least a portion of the plurality of legs include an inner diameter that is less than an outer diameter of the tube to provide a centering force to the tube.

2. The tube retainer of claim 1, wherein the body includes a flat disk shape.

3. The tube retainer of claim 2, wherein the body defines a center optical hole to allow light to pass to or from the tube.

4. The tube retainer of claim 3, wherein the body includes a plurality of circumferentially spaced holes through the disk shape.

5. The tube retainer of claim 1, wherein the plurality of flexure legs include an L shape.

6. The tube retainer of claim 1, wherein the plurality of flexure flanges are asymmetrically positioned on the body.

7. The tube retainer of claim 1, wherein the plurality of flexure flanges are less thick than the body.

8. The tube retainer of claim 1, wherein the plurality of flexure flanges and flexure legs includes at least three of each.

9. The tube retainer of claim 1, wherein the tube retainer is made of plastic or metal.

10. An optical assembly, comprising:
an optical tube;
a housing assembly surrounding the optical tube, the housing assembly comprising a plurality of mounts, wherein the optical tube axially extends past the plurality of mounts; and
a tube retainer, comprising:
a body abutting a face of the optical tube;
a plurality of flexure flanges extending radially outwardly from the body each attached to a respective mount of the plurality of mounts such that each flexure flange is flexed relative to the body to provide a retaining force to the body to bias the tube axially into the housing assembly; and
a plurality of flexure legs axially extending from the body from a tube contact side of the body, wherein the plurality of flexure legs at least partially surround the optical tube, contact an outer diameter of the optical tube, and are flexed outwardly by the outer diameter of the optical tube to provide a centering force to the tube.

11. The optical assembly of claim 10, wherein the tube retainer is sandwiched between the housing assembly and an optical component mount.

12. The optical assembly of claim 10, wherein the tube retainer is screwed down to the mounts of the housing assembly to flex the flexure flanges.

13. The optical assembly of claim 10, wherein the body includes a flat disk shape.

14. The optical assembly of claim 13, wherein the body defines a center optical hole to allow light to pass to or from the tube.

15. The optical assembly of claim 14, wherein the body includes a plurality of circumferentially spaced holes through the disk shape.

16. The optical assembly of claim 10, wherein the plurality of flexure legs include an L shape.

17. The optical assembly of claim 10, wherein the plurality of flexure flanges are asymmetrically positioned on the body.

18. The optical assembly of claim 10, wherein the plurality of flexure flanges are less thick than the body.

19. The optical assembly of claim 10, wherein the plurality of flexure flanges and flexure legs includes at least three of each.

20. The optical assembly of claim 10, wherein the tube retainer is made of plastic or metal.
